(19) United States
(12) Patent Application Publication
(10) Pub. No.: US 2007/0018013 A1
(43) Pub. Date: Jan. 25, 2007

(54) Washer nozzle and system and method for making a washer nozzle

(75) Inventors: Uwe Lasebnick, Ziegeistrasse (DE); Andreas Ritter, Royal Oak, MI (US)

Correspondence Address: MATTHEW R. JENKINS, ESQ., 2310 FAR HILLS BUILDING, DAYTON, OH, 45419, US

(73) Assignee: VALEO ELECTRICAL SYSTEMS, INC., AUBURN HILLS, MI (US)

(21) Appl. No.: 11/189,060

(22) Filed: Jul. 25, 2005

(51) Int. Cl. B29C 45/44; B05B 1/10

(52) U.S. Cl. 239/284.1; 425/577; 425/438; 425/468; 264/318

(57) ABSTRACT

An integrally formed, one-piece construction nozzle body having a primary flow channel and associated secondary flow channel and outlet configuration which cooperate to produce a jet of fluid having a predetermined geometric configuration. A system and method are also shown for creating the one-piece construction nozzle body.

### BACKGROUND OF THE INVENTION

1. Field of the Invention

This invention relates to washer nozzles and, more particularly, a washer nozzle capable of generating at least one fan jet spray and wherein the washer nozzle is an integral, one-piece molded construction suitable for use in washing or cleaning vehicle windows, windscreens, headlamps, rear lights and/or cameras and the like.

2. Description of the Related Art

Washing nozzles for use on vehicles and in particular road vehicles for applying a liquid cleaning or washing medium are known in various designs. For example, windscreen washing nozzles are known which consist of a nozzle body with a line for supplying the cleaning or washing medium with a plate-shaped nozzle chip or insert arranged in a recess of a nozzle body, such as is disclosed in WO00/12361. The insert is accommodated in form-fitting manner in the recess of the nozzle body and being provided on one side of its surface with a number of channel grooves which, when the insert is mounted in the nozzle body, forms nozzle channels that are connected to the supply channel in which each form a nozzle opening for generating a number of diverging jets of liquid or washing medium.

Also known are windscreen washing nozzles (DE 4422590A1) for generating a fan-shape or flat nozzle jet, comprising a nozzle body in which a supply channel for the liquid cleaning or washing medium is formed, which merges via a narrowing into a nozzle channel or expansion channel which expands in terms of its width in the flow direction and ends in an essentially slot-shaped nozzle opening.

It is also known (DE 1205404) to deflect a jet emerging from a single nozzle opening by means of a deflection plate provided outside the washing nozzle and thus to deform the jet such that the cleaning medium is distributed as widely as possible over the surface to be cleaned, such as a windscreen.

Known nozzles in principle have one disadvantage that the jet form and/or jet type, in particular including the droplet size thereof in the emerging nozzle jet, are not sufficient for optimal cleaning or wiping effect, and/or the volume stream and thus the consumption of liquid cleaning medium is too great in comparison to the effect achieved.

In U.S. Patent Application (Docket Number VAL 205 P2-WDE 0536/US) a washing nozzle for use on vehicles for applying a liquid cleaning or washing medium is provided with means for acting within the nozzle body on a main jet generated by the nozzle with a collision jet in order to modify the nozzle jet when it emerges from the nozzle body. This reference is owned by the same assignee of the present invention and is incorporated herein by reference and made a part hereof.

One drawback of the systems of the past was the difficulty with which to manufacture the nozzle bodies. In prior art designs, the nozzle bodies were typically two-piece construction, that utilized an insert for creating a desired jet. This meant that each nozzle body had to go through multiple assembling and manufacturing steps. Japanese Patent No. 2000/344062 illustrates one such insert.

What is needed, therefore, is a system and method for manufacturing a nozzle body and a nozzle body having an integral for means for acting upon, disturbing or atomizing a main jet emerging from the nozzle body with a collision jet and a nozzle body that is of a one-piece, integral construction.

### SUMMARY OF THE INVENTION

It is, therefore, an object of the invention to provide a simplified manufacturing method and system for molding the nozzle bodies to provide a one-piece construction that simplifies the manufacturing process and reduces or eliminates the need for time consuming and costly assembly operations.

Another object of the invention is to provide a system and method for manufacturing an integral, one-piece nozzle body having at least one channel for atomizing, disturbing or acting upon a main flow stream through the nozzle body so as to produce a jet of a desired geometric configuration.

Another object of the invention is to provide a system and method that will facilitate reducing or eliminating leaks from the nozzle body resulting from multiple piece construction.

It is also an object of the invention to provide a system and method for producing an outlet in the nozzle body that has a geometry of a desired geometric configuration so that the jet produced by the outlet is also of a desired geometric configuration, such as v-shaped, oval, rectangular, fan or the like.

Still another object of the invention is to provide a nozzle body having a primary flow channel and a secondary flow channel for acting upon fluid flowing through the primary flow channel to create a jet having a predetermined or desired geometry.

In one aspect, this invention comprises a washer nozzle comprising a nozzle body having a body axis and further comprising an inlet wall for defining an inlet for receiving fluid from a fluid supply, at least one outlet wall for defining at least one outlet for directing at least one jet of the fluid to a surface, and an interior wall for defining a fluid passageway coupling the inlet to the at least one outlet, the at least one outlet comprising an associated step for facilitating atomizing the fluid as it exits the at least one outlet, the nozzle body being an integrally formed, one-piece construction.

In another aspect, this invention comprises a method for making a nozzle body comprising the steps of: providing a first mold member for defining an internal passageway of the nozzle body, the first mold member comprising at least one first mold member projection for defining at least one outlet passageway and at least one step in fluid communication with the at least one outlet, providing a second mold member having at least one second mold member projection for mating with the at least one first mold member projection, causing the first mold member and the second mold member to be situated in a third mold member so that the at least one first mold member projection cooperates with the at least one second mold member projection to define at least one outlet in the nozzle body when it is molded, molding the nozzle body using the first, second and third mold members, the first mold member defining an inlet wall for defining an inlet for receiving fluid from a fluid supply, at least one outlet wall for defining at least one outlet, and the fluid passageway for coupling the inlet to the at least one outlet, the at least one second mold member projection defining a predetermined outlet geometry at an end of the outlet for generating at least one jet of fluid when fluid exits the at least one outlet.

In still another aspect, this invention comprises a nozzle body molding system comprising: a first mold member having at least one first mold member projection, a second mold member having at least one second mold member projection for engaging the at least one first mold member projection, and a surrounding mold member for surrounding the first and second mold member projections during molding, the at least one of the first mold member projections and the at least one of the second mold member projections cooperating to define at least one outlet passageway in the nozzle body after the nozzle body is molded and the first, second and surrounding mold members are separated, the at least one outlet passageway comprising a primary flow path and a stepped flow path in communication with the primary flow path.

In yet another aspect, this invention comprises a method for making a nozzle body comprising the steps of: situating a first mold member against a second mold member, situating at least a portion of the first and second mold members in a third mold member, and molding the nozzle body using the first, second and third mold members, the first and second mold members cooperating to define an inlet, at least one outlet and an internal passageway for joining the inlet to the at least one outlet, wherein the at least one outlet comprises an atomizing channel for atomizing fluid as it exits the at least one outlet.

These and other objects and advantages of the invention will be apparent from the following description, the accompanying drawing and the appended claims.

### BRIEF DESCRIPTION OF ACCOMPANYING DRAWING

FIG. 1 is a simplified view of a plurality of washing nozzles mounted in proximity to a windshield of a vehicle and coupled to a fluid supply;

FIG. 2 is view of a nozzle body in accordance with one embodiment of the invention;

FIG. 3A is an enlarged sectional view taken along the line 3A-3A in FIG. 7;

FIG. 3B is an enlarged sectional view taken along the line 3B-3B in FIG. 7;

FIG. 3C is an enlarged sectional view taken along the line 3C-3C in FIG. 7;

FIG. 4 is a sectional view of the nozzle body shown in FIG. 2;

FIG. 5 is another sectional and perspective view of the nozzle body shown in FIGS. 2 and 4;

FIG. 6 is a sectional fragmentary view taken along line 6-6 in FIG. 4;

FIG. 7 is sectional fragmentary view illustrating a plurality of primary flow channels and associated outlets with each of the primary flow channels having a secondary flow channel for acting upon, disturbing, atomizing or the like the fluid flowing through the primary flow channels to create a jet having a predetermined or desired geometric configuration;

FIGS. 8A-8K show various illustrative geometric configurations for the outlets to create one or more jets having a desired jet configuration;

FIG. 9 is an exploded view of a molding system in accordance with one embodiment of the invention;

FIG. 10 is a view of the molding system illustrated in FIG. 9 in a closed position, but before plastic or molding material is injected to provide the nozzle body;

FIG. 11 is an enlarged view of the area 11 in FIG. 10 illustrating the engagement of a plurality of first projection members of a first molding member against a plurality of second projection members, respectively, of a second molding member;

FIG. 12 is a fragmentary sectional view illustrating the forming of the primary and secondary passageways and associated outlets;

FIGS. 13A-13J illustrate various geometric configurations for a first projection member and associated second projection member to facilitate defining the geometric shape of the outlet and associated geometric shape of the jet created by the nozzle body;

FIG. 14A-14C are sectional fragmentary views showing a plurality of outlets angled at a desired predetermined angle relative to each other; and

FIG. 15 is a sectional fragmentary view showing a step at a top of an upper channel and a dual step at the top of the second channel.

### DETAILED DESCRIPTION OF PREFERRED EMBODIMENT

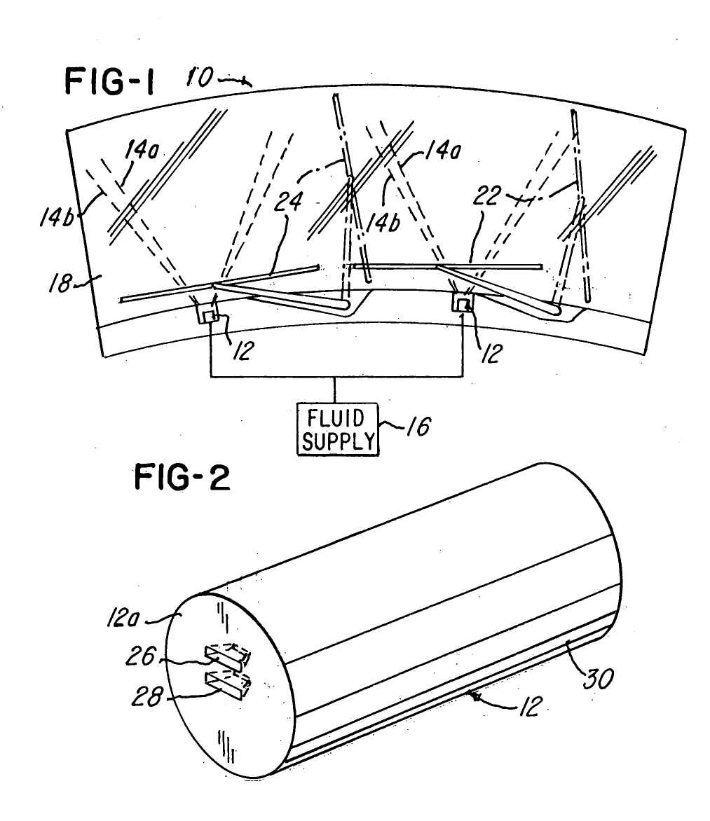

Referring now to FIG. 1, a windshield wiper washing system 10 is shown. The windshield washing system 10 comprises at least one or a plurality of washer nozzles 12 each of which is capable of directing at least one or a plurality of jets 14a-14b of fluid from a fluid supply 16 to a windshield 18 of a vehicle 20 having at least one or a plurality of windshield wipers 22 and 24. For ease of illustration, a single washer nozzle 12 will be described in FIGS. 2-13J, but it should be understood that multiple nozzles 12 may be provided for use on the vehicle 20, as illustrated in FIG. 1. Although not shown, the vehicle 20 comprises apparatus for securing the washer nozzle 12 to the vehicle 20. For example, body 26 may comprise an integrally molded quick connector (not shown) or separate connector (not shown) for mounting the washer nozzle 12 onto the vehicle 20. The washer nozzle 12 may have integrally molded mounted mounting flanges (not shown) for facilitating mounting the washer nozzle 12 onto the vehicle 20. The nozzle can be mounted on the wiper arm, hood, under the hood, on the cowl, bumper, CHSML (rear wiper module).

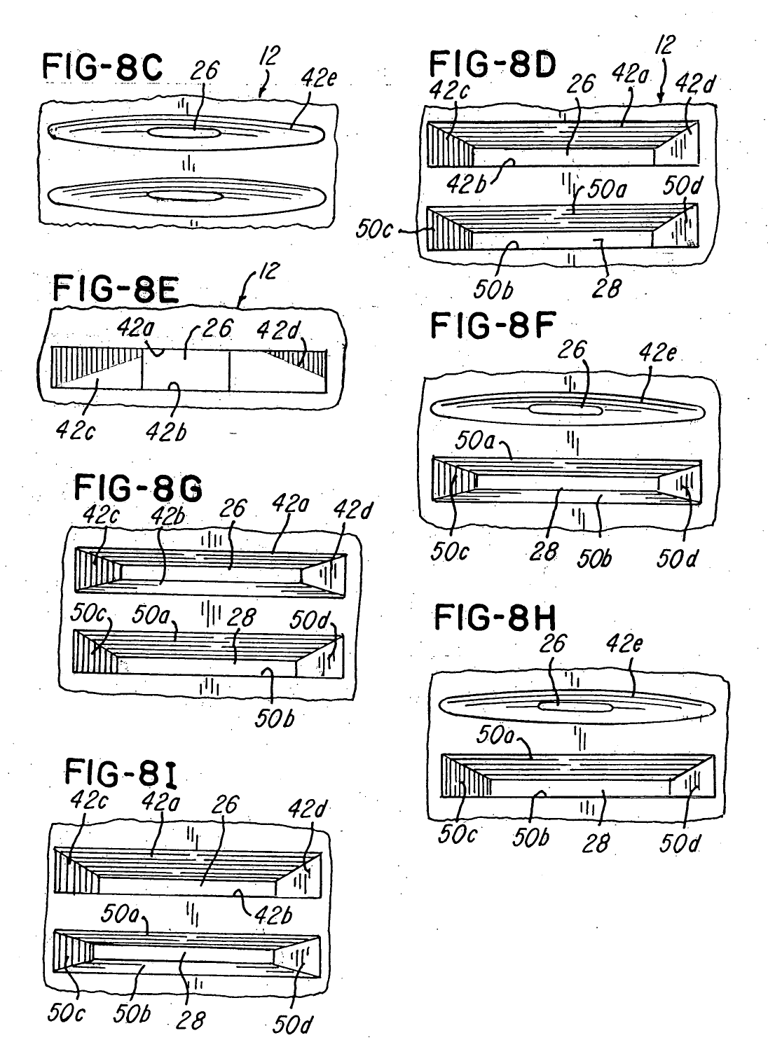

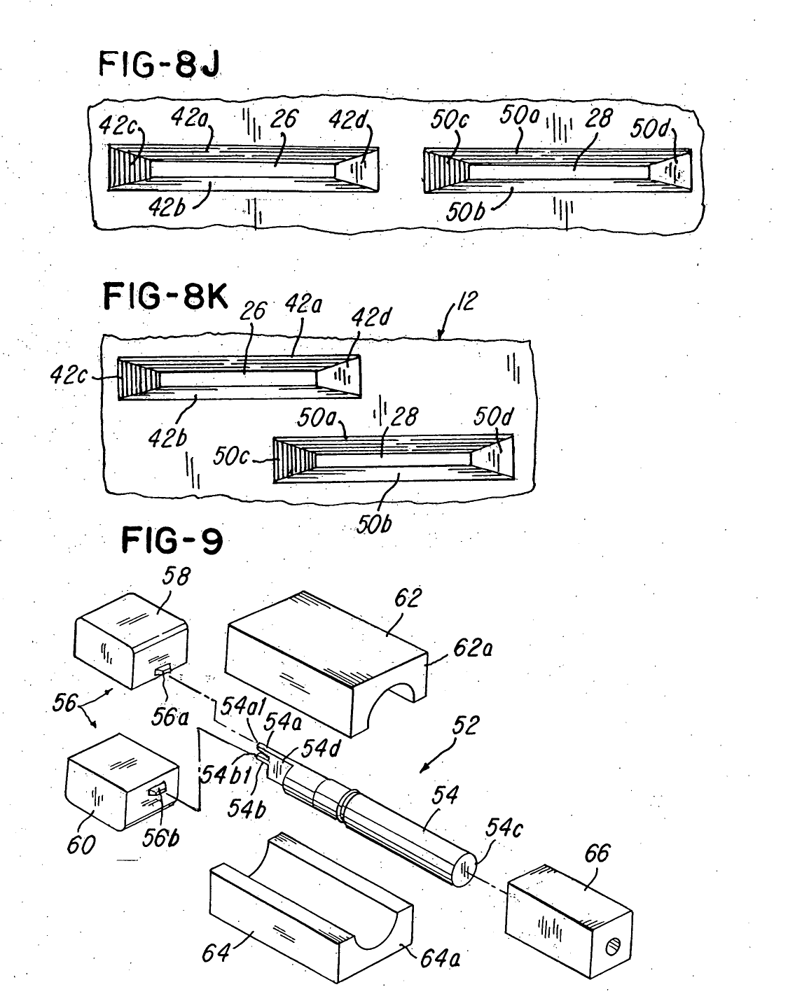

FIG. 2 illustrates an enlarged view of the washer nozzle 12 having a first outlet 26 and a second outlet 28 situated at a nozzle end 12a of the washer nozzle 12. The illustration shows two outlets 26 and 28, but it should be understood that the washer nozzle 12 could have only a single outlet, as illustrated in FIG. 8E, or it could have more than two outlets if desired. It should be appreciated that the washer nozzle 12 is an integrally molded, one-piece construction that eliminates the need for inserts for creating one or more outlet passages.

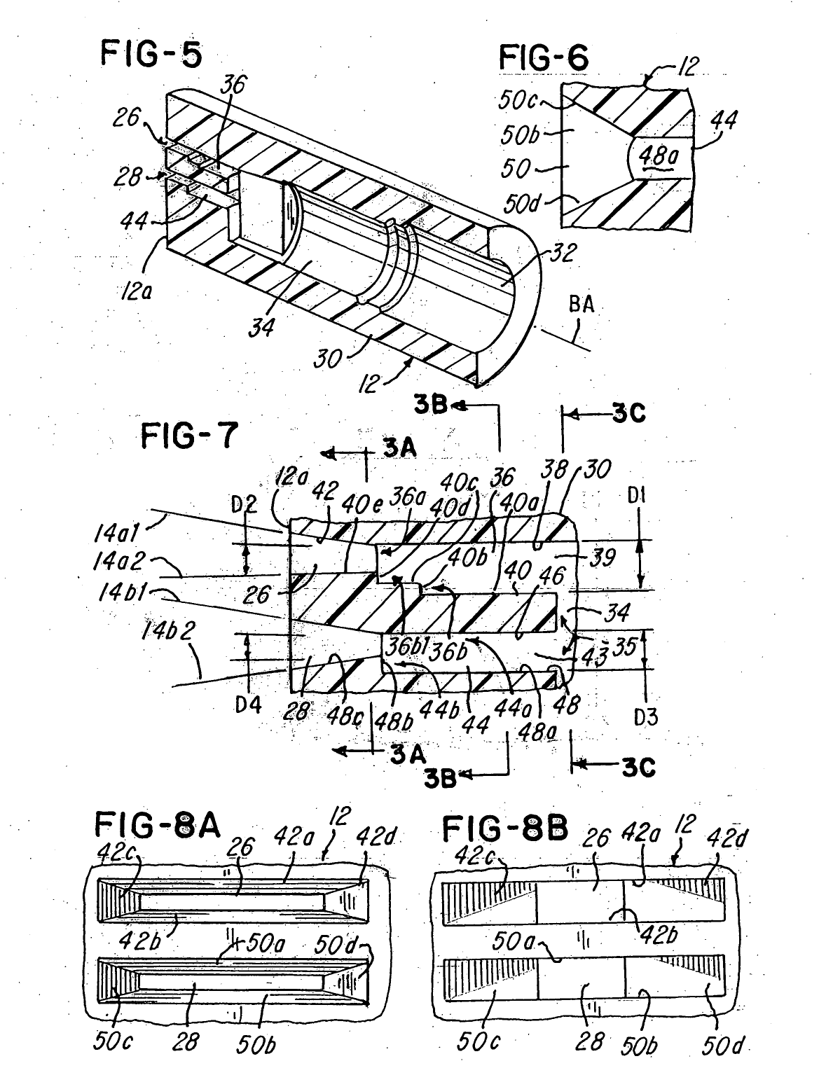

As illustrated in FIGS. 4 and 5, the washer nozzle 12 comprises a nozzle body 30 having an inlet 32 and an internal passageway 34 that couples the inlet 32 to the first and second outlets 26 and 28. Fluid flows into the nozzle body 30 in the direction of arrow A (FIG. 4) and in a direction that is generally parallel to a body axis BA (FIG. 5).

As best illustrated in FIGS. 4, 5 and 7, the first outlet 26 comprises a first outlet passageway 36 that is defined by a first wall 38 and generally opposing second wall 40. Note that the first outlet passageway 36 has a primary flow path or passageway 36a and a secondary flow path or passageway 36b. The secondary passageway 36b causes fluid to act upon, disrupt, disturb or even atomize fluid flowing through the primary passageway 36a so that fluid flowing through the outlet 26 creates a jet having a desired geometric spray configuration.

Note that the second wall 40 comprises a plurality of walls or step surfaces 40a, 40b, 40c, 40d and 40e (FIG. 7) as shown which cooperate to define at least one or a plurality of steps of the secondary flow passageway 36b. These step surfaces 40a-40e narrow the first outlet passageway 36 from a first dimension D1 (FIG. 7) to a second dimension D2 as shown. Again, the steps of the secondary passageway provides means for acting upon, atomizing or disrupting the fluid as it flows in the path 36b and exits the first outlet passageway 36.

It should be understood, as illustrated in FIG. 15, that the steps could be provided or defined at the top of the channel 36 or a channel 36 and 44 may have a dual step at the top and bottom of a channel.

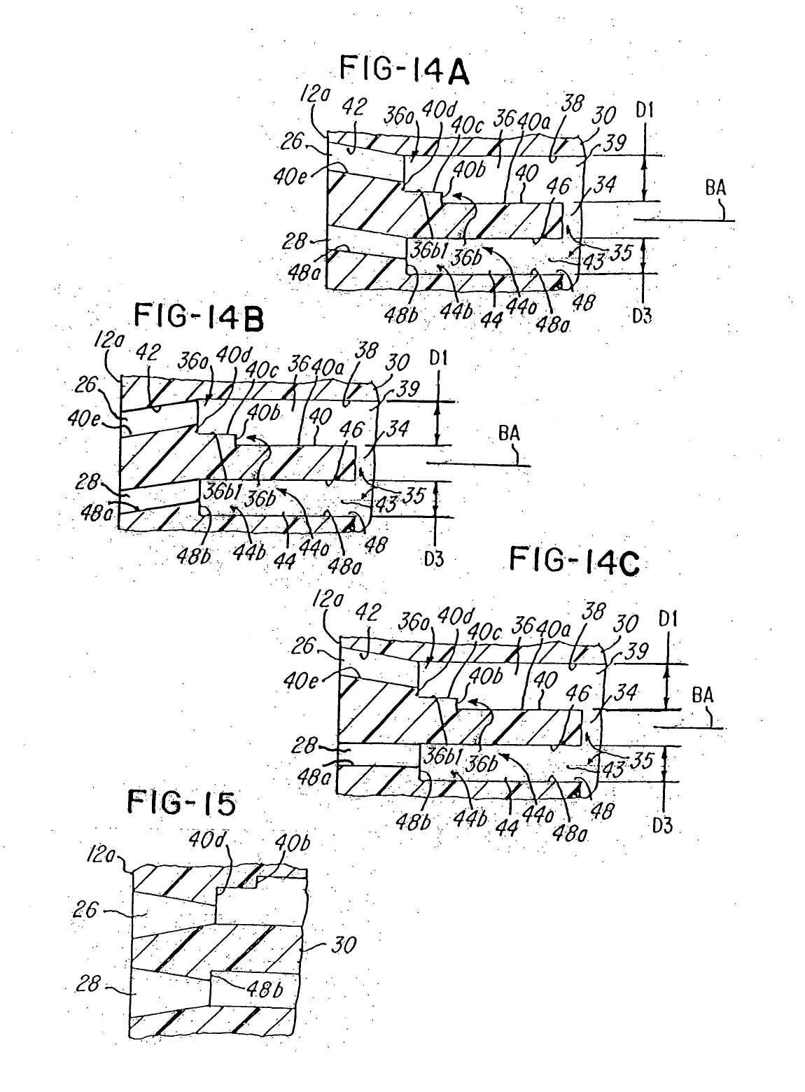

The first outlet 26 communicates with the first outlet passageway 36 and comprises a predetermined and preselected outlet wall 42 surrounding the first outlet 26. The outlet wall 42 defines a predetermined outlet geometry or shape, such as a rectangle shape, oval shape, square shape, frusto-conical or the like. As shown in FIG. 14A, the wall 42 could be angled to define the first and second outlets 26 and 28 that are angled at a predetermined angle, such as thirty degrees or less. Either one or both of the channels 26 and 28 may be angled toward or away from axis BA. Thus, the flow path of the jets 14a and 14b do not necessarily have to be parallel to axis BA. The predetermined outlet geometry is selected to cause the fluid to flow, diverge and/or fan in a desired pattern, such as the jet patterns 14a and 14b illustrated in FIG. 1. The fluid may, for example, diverge away from and perpendicular to a flow axis at distances that increase as fluid gets farther away from end 12a. A method for forming the outlet wall 42 is described later herein.

The second outlet 28 comprises a second outlet passageway 44 (FIGS. 4, and 7) defined by a first wall 46 (FIG. 7) and a generally opposing second wall 48. As with the first outlet passageway 36, the second outlet passageway 44 comprises a primary flow path or passageway 44a and a secondary flow path or passageway 44b. The second wall 48 comprises a plurality of walls or step surfaces 48a, and 48b that define a step or channel for causing fluid to act upon, disrupt or atomize fluid flowing through the primary flow passageway 44a. The step surfaces 48a and 48b narrow the second outlet passageway 44 from a first dimension D3 to a second dimension D4 as shown. Again, the step defined by surfaces 48a and 48b cooperates with wall 46 to facilitate causing the fluid flowing through the secondary flow path 44b to act upon, disrupt or atomize the fluid as it exits the second outlet passageway 44 and the second outlet 28.

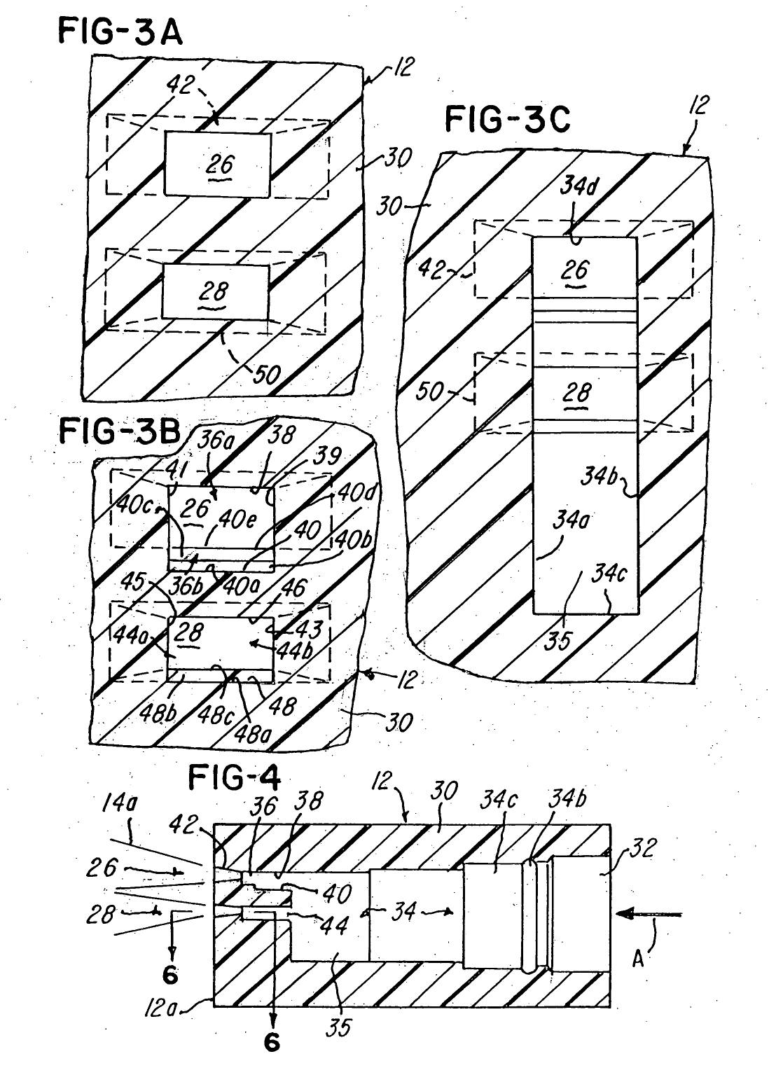

As shown in FIG. 3A, the first outlet 26 comprises the associated outlet wall 42 and second outlet 28 comprises an associated outlet wall 50. The outlet walls 42 and 50 will be described in detail later herein. As mentioned earlier, the second outlet 50 could define the second outlet 28 to be angled toward or away from axis BA, so that the jets 14a and 14b created by the outlets 26 and 28, respectively, do not have to be parallel to the axis BA. In the embodiment being described, the outlet walls 42 and 50 could be angled, for example, up to thirty degrees, as illustrated in FIG. 14B.

It should also be understood that the outlet walls 42 and 50 could be angled so that the jets 14a and 14b flow at different angles relative to each other. For example, FIG. 14C shows the first outlet 26 causes jet 14a to flow away from axis BA, while outlet 28 causes jet 14b to flow generally parallel to axis BA.

The internal passageway 34 comprises a generally rectangular feeder channel 35 (FIG. 3C) defined by walls 34a, 34b, 34c and 34d. The feeder channel 35 directs fluid from the inlet 32 into each of the primary flow passages 36a and 44a and second flow passages 36b and 44b. Note that the first outlet passageway 36 may be rectangular or square in cross-section and has walls 38, 40, 39 and 41. Likewise, the second outlet passageway 44 may be rectangular or square in cross-section and has walls 46, 48, 43 and 45.

The first outlet passageway 36 comprises the predetermined and preselected outlet wall 42 and second outlet passageway 44 comprises a predetermined and preselected outlet wall 50 surrounding the second outlet 28. The outlet walls 42 and 50 define a predetermined outlet geometry or shape, such as a rectangle shape, oval shape, square shape or the like. The predetermined outlet geometry of the outlet walls 42 and 50 are selected to cause fluid to flow and/or fan outward away from an axis of fluid flowing through the second outlet and in a pattern that increases as the fluid gets farther from the nozzle body end 12a.

It should be understood that the washer nozzle 12 may comprise only a single outlet, such as first outlet 26 as illustrated in FIG. 8E, or a plurality of outlets 26 and 28 as illustrated in several of the other Figures. The outlets 26 and 28 may have associated outlet walls 42 and 50 that have the same or different preselected or predetermined outlet geometries so that the first and second outlets 26 and 28 generate jets 14a and 14b (FIGS. 1 and 5), respectively, having the same or different geometric shapes or patterns. Also, the outlet walls 42 and 50 may have one or more tapered surfaces or walls. FIGS. 8A-8J show various illustrative configurations for the outlets 26 and 28 and associated walls 42 and 50. Common part numbers are used in the FIGS. 8A-8J for ease of understanding and simplification. Notice, for example, that wall 42 in FIG. 8A has tapered top and/or bottom walls 42a and 42b (as viewed in the figure) and tapered side walls 42c and 42d. The outlet wall 50 for the second outlet 28 has walls 50a-50d of a similar geometric configuration. These configurations cause the fluid to exit first and second outlets 26 and 28 and create jets 14a and 14b (FIG. 1) that generally diverge or fan away from (i.e., in a direction perpendicular to a fluid flow direction) as fluid exits the first and second outlets 26 and 28, respectively.

By way of contrast, notice the illustration shown relative to FIGS. 7 and 8I. Notice the second outlet wall 50 (FIG. 8I) comprises the walls 50a-50d that are each tapered away from an axis of second outlet 28. The outlet wall 42 associated with first outlet 26 has three tapered walls or surfaces 42a, 42c and 42d, but one wall or surface 42b that is generally planar, straight and not tapered. This generates the first jet 14a (FIG. 5) having a plurality of edges, such as a first jet edge 14a1 (as viewed in the side view in FIG. 7) and a second jet edge 14a2 and the second jet 14b having a first jet edge 14b1 and a second jet edge 14b2 as shown. Note that the second jet edge 14a2 of the first jet 14a can be generally parallel to the fluid flow direction or the axis BA (FIG. 5), while the jet edge 14a1 tapers or diverges away from the fluid flow direction as fluid exits the first outlet 26. The edges 14b1 and 14b2 of jet 14b taper or diverge away from the fluid flow direct as fluid exits second outlet 28. As mentioned earlier, these jets 14a and 14b and their associated edges could be angled in any desired direction and may, for example, angle or taper away from axis BA.

Thus, it should be understood that the outlet walls 42 and 50 may comprise numerous configurations as may be selected depending upon the desired geometric pattern of the jet. For example, FIG. 8A illustrates a fragmentary view showing the first and second outlets 26 and 28 being generally rectangular and having associated tapered walls. FIG. 8B illustrates generally square first and second outlets 26 and 28 with flat or planar walls 42a, 42b, 50a and 50b, but tapered side walls 42c, 42d, 50c and 50d. FIG. 8C illustrates the first and second outlets 26 and 28 being generally oval in shape and having a single surrounding tapered wall 42e and 50e, as shown. FIG. 8D illustrates the first and second outlets 26 and 28 having outlet walls or surfaces 42a, 42c, 42d, 50a, 50c and 50d being generally rectangular but with walls or surfaces 42b and 50b being generally flat or planar. FIGS. 8F and 8H illustrate the first outlet 26 being oval and having an associated oval tapered wall 42e. The second outlet 28 comprises a rectangular geometry and tapered wall, with the wall 50b in FIG. 8H being generally straight or planar. FIG. 8G shows a similar configuration as 8I, but with the wall 42b being tapered in 8G and wall 50b being generally straight or planar. These are merely illustrative examples and it should be understood that the first and second outlets 26 and 28 may comprise various outlet geometries defined by associated walls 42 and 50, any portion of which may be tapered or non-tapered. For example, the wall 42e in FIG. 8C may be non-tapered so that it provides a generally straight, planar non-tapered oval opening or outlet. Again, the shape of or geometry of the walls 42 and 50 and outlets 26 and 28, respectively, are selected depending upon the application and the shape of the jets 14a and 14b desired.

Not only can the shape and geometry of the first and second outlets 26 and 28 and their associated walls 42 and 50 be selected as desired, but the number and arrangement of the outlets 26 and 28 can be changed or selected depending upon the application. For example, the illustrations in FIGS. 8A, 8B, 8D, 8F-I show the first and second outlets 26 and 28 in a stacked (as viewed) configuration, with the first outlet 26 being arranged above the second outlet 28. In contrast, note that FIG. 8J shows the outlets 26 and 28 in a side-by-side arrangement. FIG. 8E illustrates a washer nozzle 12 having only one outlet 26. FIG. 8K shows the outlets in a staggered or offset configuration.

Thus, the invention permits the number of outlets and arrangement of those outlets to be selected in order to provide the washer nozzle 12 capable of generating one or a plurality of fluid jets, such as jets 14a and 14b, having the predetermined or desired configuration. The first and second predetermined outlet geometries in the illustration being described are selected based upon the environment in which the washer nozzle 12 is used. If it is desired, for example, to provide a large volume of fluid to an area of the windshield 18 (FIG. 1), then it may be desirable to select an outlet 40 having a generally square, but relatively large, outlet opening, such as the outlets 26 and 28 illustrated in FIGS. 8B and 8E. The geometry selected may vary depending on the targeted spray area on the windshield 18, which is very different for every vehicle. Also, the placement of the nozzle 12 relative to the windshield 18 and the obstruction of the jets 14a and 14b by the wiper arms 22, 24 may require a different nozzle 12 and the nozzle 12 configuration for each application.

A system and method for making the nozzle body 30 will now be described relative to FIGS. 9-13J.

A nozzle body molding system 52 is shown comprising a first mold member 54 having at least one or a plurality of first mold member projections 54a and 54b (FIG. 9). A second mold member 56 having at least one or a plurality of second mold member first and second projections 56a and 56b is provided for engaging and mating with the first mold member projections 54a and 54b, respectively, as described herein. In the illustration being shown, the second mold member 56 may comprise a first body member 58 comprising the second mold member first projection 56a and a second body member 60 comprising a second mold member second projection 56b. It should be understood that the illustration shown in FIG. 10 is used to demonstrate the molding of a nozzle body 30 having the plurality of outlets, such as the first and second outlets 26 and 28, described earlier relative to FIG. 8I. However, if it is desired to create a nozzle body 30 having a single outlet 26 as illustrated in FIG. 8E, then a first mold member (not shown) having only a single first mold member projection 54a would be used with a second mold member 56 having only a single second mold member projection 56a. This is one reason why it is convenient to provide the second mold member 56 may be provided in the same or separate body members 58 and 60. Thus, the first and second mold members 54 and 56 used during the molding process are provided or selected with their respective projections based upon the number of outlets desired to mold into the nozzle body 30 and depending upon the desired geometric configuration of the jets 14a and 14b.

The system 52 further comprises an upper mold member 62, a lower mold member 64 and an end mold member 66 for sealing the ends 62a and 64a of the upper and lower mold members 62 and 64 when the mold members 62 and 64 are closed around first mold member 54, as illustrated in FIG. 10. Although not shown, the end mold member 66 may be integrally formed onto an end 54c of the first mold member 54 but is shown separated therefrom for ease of illustration.

During a molding process, the mold members 54, 56, 60, 62, 64 and 66 are arranged as illustrated in FIG. 10. Notice in FIGS. 10-12 that the projections 54a and 54b engage or mate with the projections 56a and 56b, respectively, when the mold members 56 and 58 are moved to a molding position shown in FIG. 10. Notice in the enlarged views of FIGS. 11 and 12 that the ends 54a1 and 54b1 have associated dimensions D5 and D6, respectively, that are slightly larger than the dimensions D2 and D4 (FIG. 12), respectively, of ends 56a1 and 56b1. This facilitates defining the secondary flow channels 36b and 44b described earlier herein relative to FIG. 7 when the nozzle body 30 is molded. Note also that the projection 54a may comprise a step 54a2 (FIG. 11) that is defined by walls or surfaces 54a2i and 54a2ii. This facilitates defining walls 40b and 40c in the nozzle body 30 (FIG. 7), respectively, that provides a step in the secondary passageway 36b, as shown in FIGS. 7 and 12. This additional step can be in passageway 36 (as shown) and/or in passageway 44.

As shown in FIGS. 7 and 11, the ends 54a1 and 54b1 of projections 54a and 54b engage and mate with ends 56a1 and 56a2, respectively, prior to molding the nozzle body 11. They remain engaged during the molding process.

The second projection member 56 may comprise an elongated and planar portion 54d (FIG. 9) which forms the generally complementary-shaped channel 35 (FIGS. 3C and 4) in the nozzle body. The first mold member 54 may also comprise ribs or stepped areas 54e and 54f, for example, which forms the complementary shaped grooves 34b and 34c (FIG. 4) in the interior of nozzle body 30. The grooves 34b and/or 34c may be useful for mounting a chip, check valve, heater or the like. A quick connector, check valve or the like, which would just snap in groove 34b for ease of assembly of the nozzle 12 to the washer system 10.

After the mold members 54, 56, 60, 62 and 64 are arranged as shown in FIG. 10, a plastic is injected, for example, into the injection opening 66a or any other suitable injection opening location. After the mold members 54 and 56 are separated from each other, the nozzle body 30 is provided having the channel 36 and associated outlet 26 and channel 44 and associated outlet 28.

After molding, the mold members 54, 56, 60, 62, 64 and 66 are separated and the first mold member 54 and mold member 66 are withdrawn from the nozzle body 30 in the directions of arrows B and C (FIG. 10), respectively, the integrally formed washer nozzle 12 having the outlets 26 and 28 integrally formed therein is provided. After forming the nozzle body 30, the inlet 32, the primary flow path or passageway 36a, 44a, secondary flow path or passageway 36b, 44b, and associated outlets 26 and 28 and outlet walls 42 and 50, respectively are integrally formed. Notice that a relatively linear flow path is defined through the nozzle body 30, and it is generally parallel to axis BA in FIG. 5.

It should be understood that the first and second projection members 56a and 56b of the second mold member 56 each comprise a predetermined outlet geometry that generally corresponds to the predetermined or desired outlet geometry referenced to earlier relative to FIGS. 8A-8J so that the first and second outlets 26 and 28 provide jets 14a and 14b comprising the desired jet geometry. As mentioned earlier, various combinations of the outlet geometries and shapes may be provided in the outlets 26 and 28 and outlet walls 42 and 50, respectively, at the end 12a of the washer nozzle 12. It should be understood that the projections 54a, 54b and 56a and 56b are selected to define the different outlet geometries which will vary depending upon the desired shape of the jets 14a and 14b. For example, the nozzle body 30 may be provided with a single outlet opening (FIG. 8E) having a predetermined outlet geometry, such as an oval geometry, rectangular geometry, frusto-conical or square outlet geometry. Alternatively, a dual outlet, such as the outlet 26 and 28, for example, may be provided in the end 12a of the washer nozzle 12.

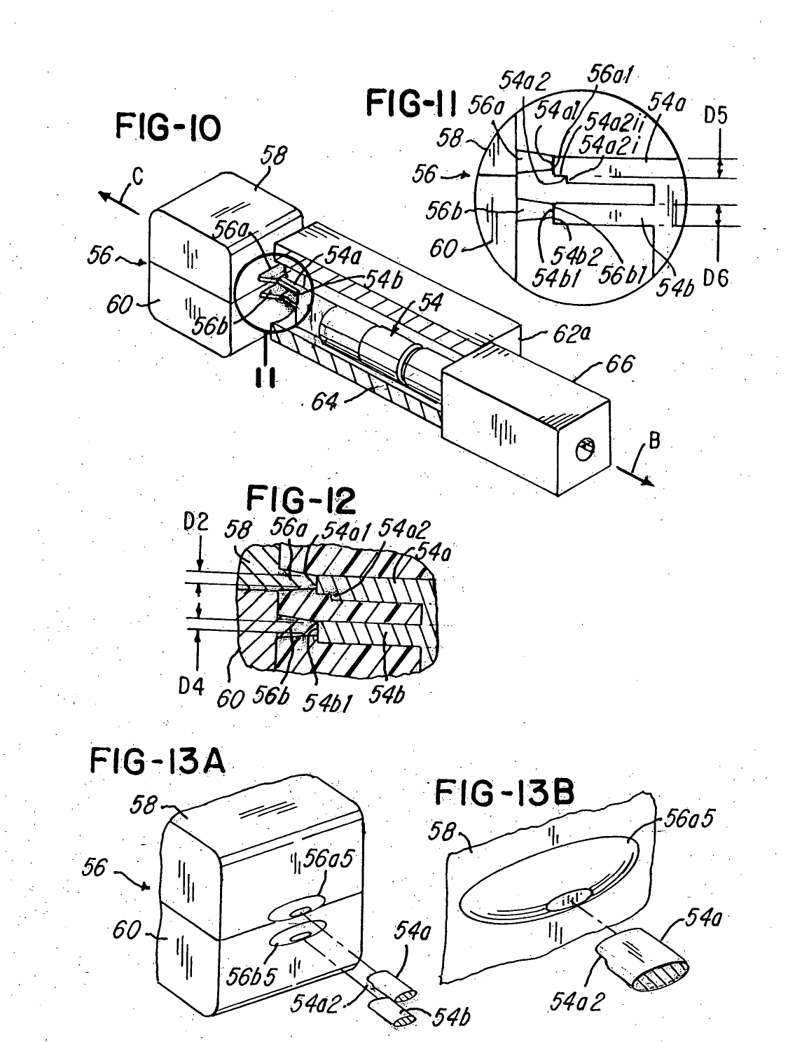

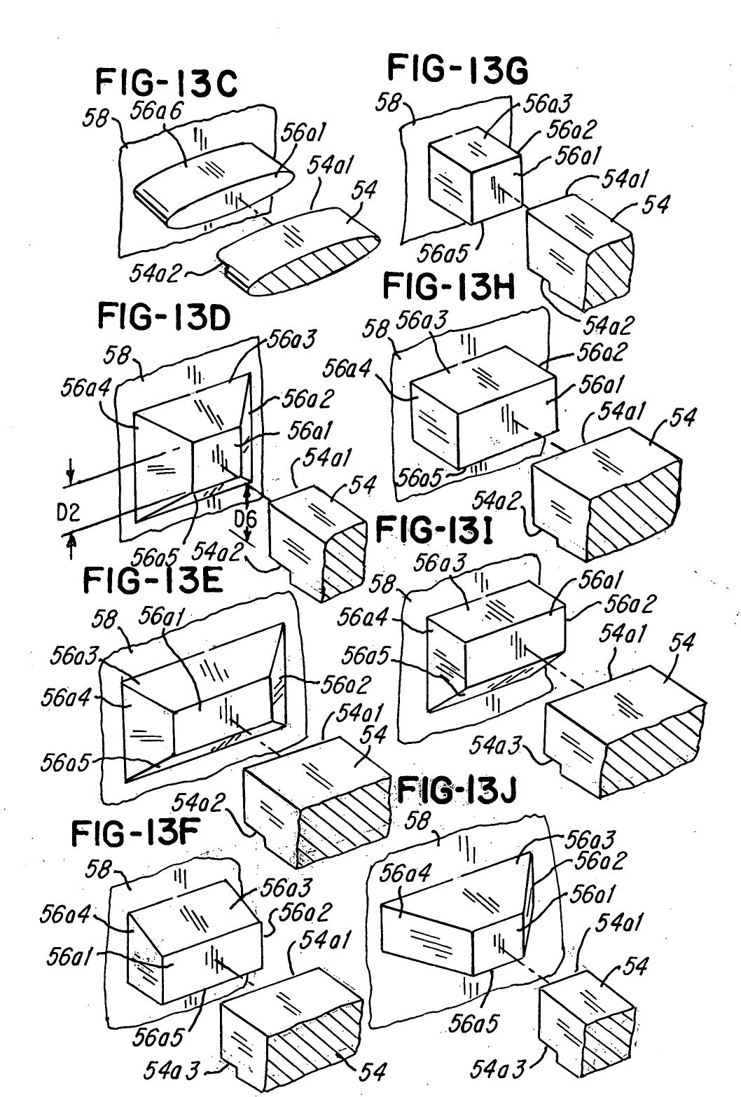

Thus, the predetermined outlet geometry selected for the first outlet 26 and the second outlet 28 are defined by the first and second mold member projections 54a, 54b, 56a and 58a, respectively. FIGS. 13A-13J illustrate various mold member projections 54a and 56a that may be used to define the outlet geometries. For ease of illustration, FIGS. 13B-13J show only projection 54a and one mating projection 56a, but it should be understood that mold members 54 and 56 having more projections may be provided and used, depending on the number of outlets 26 and 28 being formed in the nozzle body 30 as mentioned earlier. Also, mold member projection geometries other than those shown may be used and selected in order to provide the outlets 26 and 28 having the desired outlet geometries. To create and form these shapes and outlet geometries, corresponding first and second mold members 54 and 56 having the projections 54a, 54b, 56a and 56b of the corresponding desired geometries are selected. For example, FIGS. 13A and 13B show illustrative dual and single projections 54a, 54b, 56a and/or 56b that cooperate to define an interior channel 34 and outlet 26 that is oval in cross section, with an oval tapered wall 42e in FIG. 8C.

Although it is possible to have the ends 54a1 and 54b1 generally complement each other to form a continuously-shaped interior channel, they may comprise different cross-sectioned dimensions (such as dimensions D5 and D6 in FIG. 11) to provide or define one or more secondary flow paths 36b and 44b, as illustrations in FIG. 7.

As mentioned earlier relative to FIGS. 4, 7, 11 and 12, notice the projection members 54a and 54b comprise dimensions D5 and D6 (FIG. 11) that are slightly larger than dimension D2 and D4 (FIG. 7), respectively, so that the nozzle body 30 will be formed with and comprise the steps surfaces 40a, 40b, 40c, 40d, 48a and 48b which cooperate to define the secondary flow paths 36b and 44b, respectively, or steps in the channels 36. Again, the end 54a1 of first projection member 54a may have the step 54a2 (FIG. 11), which defines the surfaces 40b and 40c (FIG. 7) to provide a secondary flow channel or second step channel or area 36b1 associated with channel 36 (FIG. 7).

Referring to FIGS. 13A-13J, various illustrative geometries or shapes for the projections 54a, 54b, 56a and 56b are shown. It should be understood that these illustrations and the Table I below are not exhaustive and other configurations, shapes or geometries may be selected or provided, depending on the size and geometric shape of channels 36 and 44, their associated outlets 26 and 28 and the geometric shape or configuration of the jets 14a and 14b. Also, similar part numbers are used for ease of illustration and comparison. Accordingly, these figures are meant to be illustrative, not exhaustive, and the following Table I summarizes several of the features shown in FIGS. 13A-13J:

TABLE I

| | Cross-sectional shape of projections 54a, | Cross-sectional shape of |
|---|---|---|
| FIG. | 54b | projections 56a of 56b |
| 13A | Oval with steps 54a2, 56b2 | Oval, with tapered walls 56a5, 56b5 |
| 13B | Oval with step 54a2 | Oval, with tapered wall 56a5 |
| 13C | Oval with step 54a2 | Oval, straight wall 56a6 |
| 13D | Square with step 54a2 | Square, with all tapered walls 56a2, |
| | | 56a3, 56a4, 56a5 |
| 13E | Rectangular with step 54a2 | Rectangular with tapered walls 56a2, |
| | | 56a3, 56a4, 56a5 |
| 13F | Rectangular with a dual step 54a3 | Rectangular with only top wall 56a3 |
| | | (as viewed) tapered |
| 13G | Square with step 54a2 | Square, no tapered walls 56a2, |
| | | 56a3, 56a4, 56a5 |
| 13H | Rectangular with step 54a2 | Rectangular, no tapered walls 56a2, |
| | | 56a3, 56a4, 56a5 |
| 13I | Rectangular with tapered wall 54a3 to | Rectangular with tapered walls 56a3 |
| | define a ramp in nozzle body | and 56a5, planar side walls 56a2 |
| | | and 56a4 |
| 13J | Square with step 54a2 | Square with tapered side walls 56a2 |
| | | and 56a4, planar upper and lower |
| | | walls 56a3 and 56a5 |

Advantageously, this system and method reduces or eliminates entirely the need for using an insert (not shown) to define the outlets as was done in many applications in the past. Moreover, the system and method facilitates defining one or more outlet openings having a predetermined or desired outlet geometry and selected based upon the desired shape and position of jets 14a and 14b of fluid. As mentioned earlier, although the invention has been shown and described relative to a body member 30 having one or two outlet openings in the illustration, it should be understood that more outlet openings may be provided by providing mold members 54 and 56 that have a corresponding number of mating mold member projections 54a and 56a, respectively.

This system and method also facilitates molding and producing a plurality of washer nozzles 12 having the integrally formed outlet geometries 26 and 28 with the secondary flow channels 36b and 44b (FIG. 7) or stepped channels and with a corresponding outlet configuration. The system and method reduces manufacturing time and steps and reduces or eliminates one or more assembly steps of the type required in the past.

While the system and method described, constitute preferred embodiments of this invention, it is to be understood that the invention is not limited to this precise system and method, and that changes may be made in either without departing from the scope of the inventions, which is defined in the appended claims.

What is claimed is:

1. A washer nozzle comprising:
a nozzle body having a body axis and further comprising:
an inlet wall for defining an inlet for receiving fluid from a fluid supply;
at least one outlet wall for defining at least one outlet for directing at least one jet of said fluid to a surface, and
and an interior wall for defining a fluid passageway coupling said inlet to said at least one outlet;
said at least one outlet comprising an associated step for facilitating atomizing said fluid as it exits said at least one outlet;
said nozzle body being an integrally formed, one-piece construction.

2. The washer nozzle as recited in claim 1 wherein said inlet, said at least one outlet and said fluid passageway directing fluid in a fluid direction that is generally parallel to said body axis.

3. The washer nozzle as recited in claim 1 wherein said at least one outlet is angled.

4. The washer nozzle as recited in claim 3 wherein said angle is less than 30 degrees.

5. The washer nozzle as recited in claim 1 wherein said at least one outlet comprises a predetermined outlet geometry for causing said at least one jet to comprise a generally corresponding predetermined jet geometry in cross section when said fluid exits said at least one outlet.

6. The washer nozzle as recited in claim 1 wherein said associated step comprises a dual step.

7. The washer nozzle as recited in claim 1 wherein said associated step is situated on an upper channel wall of said at least one outlet wall.

8. The washer nozzle as recited in claim 5 wherein said predetermined outlet geometry comprises at least one of an oval shape, a rectangular shape or a square shape so that said at least one jet defines a rectangle, a square or an oval, respectively, in cross section.

9. The washer nozzle as recited in claim 1 wherein said at least one outlet comprises at least one tapered wall for causing said at least one jet to fan when it exits said at least one outlet.

10. The washer nozzle as recited in claim 8 wherein said at least one outlet comprises at least one tapered wall for causing said at least one jet to fan when it exits said at least one outlet.

11. The washer nozzle as recited in claim 1 wherein said at least one outlet comprises an outlet geometry so that said at least one jet comprises an upper jet edge and a lower jet edge, at least one of which is generally parallel to said body axis.

12. The washer nozzle as recited in claim 1 wherein said at least one outlet comprises an outlet geometry so that said at least one jet is generally V-shaped in cross section.

13. The washer nozzle as recited in claim 1 wherein said at least one jet comprises a first jet and a second jet, said at least one outlet comprising a first outlet and a second outlet for generating said first jet and said second jet, respectively.

14. The washer nozzle as recited in claim 13 wherein said first and second outlets are stacked.

15. The washer nozzle as recited in claim 14 wherein said first and second outlets are side-by-side.

16. The washer nozzle as recited in claim 14 wherein said first and second outlets are offset.

17. The washer nozzle as recited in claim 13 wherein said first outlet comprises a first predetermined outlet geometry and said second outlet comprises a second predetermined outlet geometry.

18. The washer nozzle as recited in claim 17 wherein each of said first and second predetermined outlet geometries comprise an oval shape, a rectangular shape or a square.

19. The washer nozzle as recited in claim 17 wherein said first and second predetermined outlet geometries are the same.

20. The washer nozzle as recited in claim 17 wherein said first and second predetermined outlet geometries are different.

21. The washer nozzle as recited in claim 13 wherein said first and second outlets are arranged vertically on an outlet end of said nozzle body.

22. The washer nozzle as recited in claim 13 wherein said first and second outlets are arranged horizontally on an end of said nozzle body.

23. The washer nozzle as recited in claim 13 wherein said first and second outlets are offset relative to each other.

24. The washer nozzle as recited in claim 13 wherein each of said first and second outlets comprise at least one tapered wall for causing said first and second jets to fan when they exit said first and second outlets, respectively.

25. A method for making a nozzle body comprising the steps of:
providing a first mold member for defining an internal passageway of said nozzle body, said first mold member comprising at least one first mold member projection for defining at least one outlet passageway and at least one step in fluid communication with said at least one outlet;
providing a second mold member having at least one second mold member projection for mating with said at least one first mold member projection;
causing said first mold member and said second mold member to be situated in a third mold member so that said at least one first mold member projection cooperates with said at least one second mold member projection to define at least one outlet in said nozzle body when it is molded;
molding said nozzle body using said first, second and third mold members;
said first mold member defining an inlet wall for defining an inlet for receiving fluid from a fluid supply, at least one outlet wall for defining at least one outlet, and said fluid passageway for coupling said inlet to said at least one outlet; said at least one second mold member projection defining a predetermined outlet geometry at an end of said outlet for generating at least one jet of fluid when fluid exits said at least one outlet.

26. The method as recited in claim 25 wherein said method further comprises the steps of:
providing said first mold member comprising a plurality of first mold member projections for defining a plurality of outlets each of which comprise at least one associated step;
providing said second mold member comprising a plurality of second mold member projections for mating with said plurality of first mold member projections so that when said nozzle body is molded, a plurality of outlets are integrally provided therein.

27. The method as recited in claim 25 wherein said outlet geometry comprises an oval shape, a rectangular shape or a square shape.

28. The method as recited in claim 25 wherein said first mold member and said inlet, said at least one outlet and said fluid passageway are generally parallel to said body axis.

29. The method as recited in claim 25 wherein said at least one outlet is angled.

30. The method as recited in claim 29 wherein said angle is less than 30 degrees.

31. The method as recited in claim 25 wherein said predetermined outlet geometry facilitates generating said at least one jet comprising a predetermined jet geometry.

32. The method as recited in claim 31 wherein said predetermined jet geometry comprises at least one of an oval shape, a rectangular shape or a square shape so that said at least one jet defines an oval, a rectangle or a square, respectively, in cross section.

33. The method as recited in claim 25 wherein said at least one second mold member projection comprises at least one tapered wall for causing said outlet to have an associated tapered wall so that said at least one jet fans when it exits said at least one outlet.

34. The method as recited in claim 25 wherein said method further comprises the step of:
providing said second mold member comprising said second mold member projection having a predetermined projection geometry selected so that said predetermined outlet geometry causes said at least one jet to comprise an upper jet edge and a lower jet edge, at least one of which is generally parallel to an axis of said nozzle body.

35. The method as recited in claim 25 wherein said method comprises the step of:
selecting a second mold member having a second predetermined projection geometry to cause said jet to be generally V-shaped in cross section.

36. The method as recited in claim 25 wherein said method further comprises the steps of:
providing a first mold member comprising a first channel projection that forms a first channel having an associated first step and a second channel projection that forms a second channel having an associated second step, and
providing a second mold member comprising a third projection and a fourth projection for mating with said first and second channel projections, respectively, to form a first outlet for generating a first jet and a second outlet for generating a second jet in said nozzle body.

37. The method as recited in claim 36 wherein said first outlet comprises a first predetermined outlet geometry and said second outlet comprises a second predetermined outlet geometry.

38. The method as recited in claim 37 wherein each of said first and second predetermined outlet geometries define an oval shape, a rectangular shape or a square shape.

39. The method as recited in claim 37 wherein said first and second predetermined outlet geometries are the same.

40. The method as recited in claim 37 wherein said first and second predetermined outlet geometries are different.

41. The method as recited in claim 37 wherein each of said first and second outlets comprise at least one tapered wall for causing said first and second jets to fan when they exit said first and second outlets, respectively.

42. The method as recited in claim 36 wherein said first and second outlets are situated vertically on an outlet end of said nozzle body.

43. The method as recited in claim 36 wherein said first and second outlets are situated horizontally on an outlet end of said nozzle body.

44. The method as recited in claim 36 wherein said first and second outlets are offset on an outlet end of said nozzle body.

45. The method as recited in claim 36 wherein said first and second outlets are offset relative to each other.

46. A nozzle body molding system comprising:
a first mold member having at least one first mold member projection;
a second mold member having at least one second mold member projection for engaging said at least one first mold member projection; and
a surrounding mold member for surrounding said first and second mold member projections during molding;
said at least one of said first mold member projections and said at least one of said second mold member projections cooperating to define at least one outlet passageway in the nozzle body after said nozzle body is molded and said first, second and surrounding mold members are separated;
said at least one outlet passageway comprising a primary flow path and a stepped flow path in communication with said primary flow path.

47. The nozzle body molding system as recited in claim 46 wherein said at least one second mold member projection defining a predetermined outlet geometry at an end of said at least one outlet passageway for causing said fluid to generate at least one jet when it exits said outlet passageway to comprise a generally corresponding predetermined jet geometry in cross section.

48. The nozzle body molding system as recited in claim 46 wherein said first mold member defines an inlet, said primary flow path and said stepped flow path in said nozzle body, said at least one outlet passageway, said inlet, said primary flow path and said stepped flow path being generally parallel to an axis of said nozzle body.

49. The nozzle body molding system as recited in claim 47 wherein said predetermined outlet geometry comprises at least one of an oval shape, a rectangular shape or a square shape so that said at least one jet defines a rectangle, a square or an oval, respectively, in cross section.

50. The nozzle body molding system as recited in claim 46 wherein an end of said at least one outlet passageway comprises at least one tapered wall for causing fluid exiting said at least one outlet passageway to fan in a predetermined configuration.

51. The nozzle body molding system as recited in claim 49 wherein said at least one second mold member projection generates a plurality of tapered walls that cause said fluid to fan when it exits said at least one outlet passageway.

52. The nozzle body molding system as recited in claim 46 wherein said at least one outlet passageway causes fluid exiting said at least one outlet passageway to comprise an upper jet edge and a lower jet edge, at least one of which is generally parallel to said body axis.

53. The nozzle body molding system as recited in claim 46 wherein said at least one second mold member projection generates an exit opening that causes fluid to exit said at least one outlet passageway in at least one jet that is generally V-shaped.

54. The nozzle body molding system as recited in claim 46 wherein said first mold member comprises a first mold member first projection and a first mold member second projection, said second mold member comprises a second mold member first projection and a second mold member second projection;
said first mold member first projection cooperating with said second mold member first projection and said first mold member second projection cooperating with said second mold member second projection during the molding process to define a first outlet passageway and a second outlet passageway, respectively, in the nozzle body.

55. The nozzle body molding system as recited in claim 46 wherein said second mold member comprises a first body member comprising said second mold member first projection and a second body member comprising said second mold member second projection, said first and second body members being separable from each other and from said first mold member.

56. The nozzle body molding system as recited in claim 54 wherein said first outlet passageway comprises a first predetermined outlet geometry at an end of said first outlet passageway and said second outlet comprises a second predetermined outlet geometry at an end of said second outlet passageway.

57. The nozzle body molding system as recited in claim 56 wherein each of said first and second predetermined outlet geometries comprise an oval shape, a rectangular shape or a square shape.

58. The nozzle body molding system as recited in claim 56 wherein said first and second predetermined outlet geometries are the same.

59. The nozzle body molding system as recited in claim 56 wherein said first and second predetermined outlet geometries are different.

60. The nozzle body molding system as recited in claim 54 wherein each of said first and second outlet passageways comprise at least one tapered wall for causing a first jet and a second jet, respectively, to fan in a predetermined direction when they exit said first and second outlets, respectively.

61. The nozzle body molding system as recited in claim 60 wherein said first and second jets have a portion that flows away from an axis of the nozzle body.

62. A method for making a nozzle body comprising the steps of:
situating a first mold member against a second mold member;
situating at least a portion of said first and second mold members in a third mold member; and
molding said nozzle body using the first, second and third mold members;
said first and second mold members cooperating to define an inlet, at least one outlet and an internal passageway for joining said inlet to said at least one outlet, wherein said at least one outlet comprises an atomizing channel for atomizing fluid as it exits said at least one outlet.

63. The method as recited in claim 62 wherein said first mold member comprises at least one first mold member projection for defining said internal passageway and said at least one atomizing channel; and said second mold member comprises at least one second mold member projection for mating with said at least one first mold member projection during molding.

64. The method as recited in claim 63 causing said at least one first mold member projection to engage said at least one second mold member projection so that when the nozzle body is molded said at least one outlet is defined in said nozzle body.

65. The method as recited in claim 63 wherein said first mold member projection defines an inlet wall for defining said inlet for receiving fluid from a fluid supply, at least one outlet wall for defining said at least one outlet, said at least one second mold member projection defining a predetermined outlet geometry at an end of said outlet for generating at least one jet of fluid having a predetermined jet geometry when fluid exits said outlet.

66. The method as recited in claim 62 wherein said method further comprises the steps of:
providing a first mold member comprising a plurality of first mold member projections for defining a plurality of outlets each of which having an associated step channel;
providing a second mold member comprising a plurality of second mold member projections for mating with said plurality of first mold member projections, respectively, to define a plurality of outlet openings.

67. The method as recited in claim 66 wherein said plurality of outlet openings comprise a plurality of different cross sectional shapes in order to generate a plurality of different jet geometries.

68. The method as recited in claim 65 wherein said predetermined outlet geometry comprises an oval shape, a rectangular shape or a square shape.
